(19) United States
(12) Patent Application Publication
(10) Pub. No.: US 2014/0089004 A1
(43) Pub. Date: Mar. 27, 2014

(54) PATIENT COHORT LABORATORY RESULT PREDICTION

(71) Applicant: UNIVERSITY OF UTAH RESEARCH FOUNDATIO, Salt Lake City, UT (US)

(72) Inventors: Lewis J. FREY, Salt Lake City, UT (US); Leslie A. LENERT, Salt Lake City, UT (US)

(73) Assignee: UNIVERSITY OF UTAH RESEARCH FOUNDATION, Salt Lake City, UT (US)

(21) Appl. No.: 13/629,473

(22) Filed: Sep. 27, 2012

(51) Int. Cl. G06Q 50/24

(52) U.S. Cl. 705/3

(57) ABSTRACT

A computer-based tool and associated methods use biological sequence analysis techniques to predict clinical outcomes, such as diagnostic test results, for a patient based on outcome behaviors in cohorts of similar patients.

### FIELD

The subject technology relates to methods of predicting laboratory test results for patients in order identify patients that have a high probability of going out of range of a laboratory test based on patterns of similar cohorts of patients.

### BACKGROUND

A patient's electronic medical record contains data that can be used by a clinician to evaluate and treat a patient. A collection of patient electronic medical records may be vast in amount, especially when clinicians provide long-term care to patients or when clinicians provide care to many different patients. Processing this large amount of medical information can therefore be difficult.

### SUMMARY

The subject technology is illustrated, for example, according to various aspects described below. Various examples of aspects of the subject technology are described as clauses. These clauses are provided as examples and do not limit the subject technology. It is noted that any of the dependent clauses may be combined in any combination, and placed into a respective independent clause. The other clauses can be presented in a similar manner.

In some embodiments, is a method of predicting patient test results for a patient comprising; receiving, by a processor, data files, each of the files representing results of a diagnostic test; a annotating each of the files with a respective indicator of a time associated with the respective test, to create a respective patient test result; comparing the first sequential record to other time-sequential records, of other patients; identifying a cohort of patients having similar sequential records by determining which of the other sequential records have a degree of similarity to the first sequential record; and predicting, by a processor, at least one future patient test result having a significant probability of being out of predetermined range.

In some embodiments, the method includes outputting, to an output device, the at least one patient test result. In some embodiments, the respective test annotated with the respective indicator of time is identified using a natural language processing technique. In some embodiments, in the step of identifying a cohort of patients having similar sequential records by determining which of the other sequential records have a degree of similarity to the first sequential record, a dynamic programming algorithm is used to obtain the cohort of similar sequential records.

In certain embodiments, the algorithm comprises:

$$H ( , j ) = max \{ \begin{matrix}0 \\ H ( i - 1 , j - 1 ) + w ( {a}_{i} , {b}_{j} ) match \text{/} mismatch \\ H ( i - 1 , j ) + w ( {a}_{i} , - ) deletion \\ H ( , j - 1 ) + w ( - , {b}_{j} ) insertion\end{matrix} \} , \\ 1 \leq i \leq m , 1 \leq j \leq n .$$

In some embodiments, the at least one future patient test result that was out of predetermined range for the cohort is selected from the group consisting of: blood pressure, cholesterol level, and blood glucose level. In some embodiments, the other time-sequential records comprises over one million sequential records. In some embodiments, the method includes a step of predicting when the at least one future patient test will go out of predetermined range for the patient. In some embodiments, the method includes a step of outputting to an output device when the at least one future patient test result will go out of predetermined range.

In some embodiments, the method includes a step of prioritizing, by a clinician, the significance of the respective test. In some embodiments, the step of identifying a cohort includes identifying, by a processor diagnostic tests that were out of predetermined range in the cohort of patients having similar sequential records for patients. In some embodiments the interventions that are annotated are selected from the group consisting of, blood pressure, cholesterol, and blood glucose level.

According to some embodiments, is a non-transitory computer-readable medium encoded with a computer program comprising instructions executable by a processor for: receiving, by a processor, data files, each of the files representing a patient test result; annotating each of the files with a respective indicator of a time associated with the respective test result, to create a respective patient test result; based on the indicators, creating a first time-sequential record of the patient, comprising each test result; identifying a cohort of patients having similar sequential records by determining which of the other sequential records have a degree of similarity to the first sequential record; comparing the first sequential record to other time-sequential records, of other patients; identifying a cohort of patients having similar sequential records by determining which of the other sequential records have a degree of similarity to the first sequential record; and predicting, by a processor, at least one future patient test result having a significant probability of being out of a predetermined range for the cohort.

In certain embodiments, the instructions further comprise code for outputting, to an output device, the identified at least one patient test result that had the highest likelihood of being out of predetermined range for the cohort. In some embodiments the instructions further comprise code for identifying the respective test result using a natural language processing technique. In some embodiments, the instructions comprise code for using a dynamic programming algorithm to obtain the cohort of similar sequential records. In some embodiments, the instructions comprise code for using the following an algorithm comprising:

$$H ( , j ) = max \{ \begin{matrix}0 \\ H ( i - 1 , j - 1 ) + w ( {a}_{i} , {b}_{j} ) match \text{/} mismatch \\ H ( i - 1 , j ) + w ( {a}_{i} , - ) deletion \\ H ( , j - 1 ) + w ( - , {b}_{j} ) insertion\end{matrix} \} , \\ 1 \leq i \leq m , 1 \leq j \leq n$$

In some embodiments, the one patient test result that had the highest likelihood of being out of predetermined range for the cohort is selected from the group consisting of: blood pressure, cholesterol level, and blood glucose level. In some embodiments, the instructions further comprise code for accessing over one million sequential records. In some embodiments, the instructions further comprise code for a step of predicting when the at least one future diagnostic test will go out of predetermined range for the patient. In some embodiments, the instructions further comprise code for outputting to an output device, when the future patient test result will go out of range. In some embodiments, the instructions further comprise code for inputting, by a clinician, prioritizing data of the significance of the respective test.

In some embodiments, the step of identifying a cohort further comprise code for identifying, by a processor test results which were out of predetermined range in the cohort of patients having similar sequential records for patients. In some embodiments, the test results that are annotated are selected from the group consisting of blood pressure, cholesterol level, and blood glucose level. In some embodiments, the instructions further comprise code for processing by distributed computers.

According to certain embodiments, the instructions further comprise code for processing patient files in the Veterans Affairs Informatics and Computing Infrastructure.

According to some embodiments, disclosed is a computing machine comprising the machine-readable medium encoded with a computer program comprising instructions executable by a processor for: receiving, by a processor, data files, each of the files representing a patient test result; annotating each of the files with a respective indicator of a time associated with the respective test result, to create a respective patient test result; based on the indicators, creating a first time-sequential record of the patient, comprising each test result; identifying a cohort of patients having similar sequential records by determining which of the other sequential records have a degree of similarity to the first sequential record; comparing the first sequential record to other time-sequential records, of other patients; identifying a cohort of patients having similar sequential records by determining which of the other sequential records have a degree of similarity to the first sequential record; and predicting, by a processor, at least one future patient test result having a significant probability of being out of predetermined range for the cohort.

In some embodiments is a system for predicting patient test results for a patient, comprising: patient data file input module configured to receive, by a processor, data files, each of the files representing a patient test result; and a processing module, wherein the processing module is configured to annotate each of the files with a respective indicator of a time associated with the respective diagnostic test, to create a respective patient test record; based on the indicators, create a first time-sequential test record of the patient, comprising each patient diagnostic test; compare the first sequential test record to other time-sequential records, of other patients; identify a cohort of patients having similar sequential records by determining which of the other sequential records have a degree of similarity to the first sequential record; and predict, by a processor, at least one future patient test results having a significant probability of being out of predetermined range for the cohort

In some embodiments, the system comprises an output module configured to output the identified at least one patient test results that had the highest likelihood of being out of predetermined range for the cohort. In some embodiments, the processor is configured to use a natural processing language technique to identify the respective test result. In some embodiments, the processor is configured to use a dynamic programming algorithm to obtain the cohort of similar sequential records. In some embodiments, the dynamic programming algorithm comprises,

$$H ( , j ) = max \{ \begin{matrix}0 \\ H ( i - 1 , j - 1 ) + w ( {a}_{i} , {b}_{j} ) match \text{/} mismatch \\ H ( i - 1 , j ) + w ( {a}_{i} , - ) deletion \\ H ( , j - 1 ) + w ( - , {b}_{j} ) insertion\end{matrix} \} , \\ 1 \leq i \leq m , 1 \leq j \leq n$$

In some embodiments, the at least one patient test result having a significant probability of being out of predetermined range for the cohort is selected from the group consisting of: blood pressure, cholesterol level, and blood glucose level. In some embodiments, the processor is configured to access the other time-sequential records comprising over one million sequential records. In some embodiments, the processor is configured to predict when the at least one future diagnostic test will go out of predetermined range for the patient. In some embodiments, the processor is configured to output to an outputting device when the at least one future diagnostic test will go out of predetermined range for the patient. In some embodiments, the processor is configured to receive data from a clinician prioritizing the significance of the respective test result. In some embodiments, the processor is configured to identify patient test results that are out of predetermined range for the cohort.

According to certain embodiments, the respective test results used to create the first time-sequential record are selected from the group consisting of blood pressure, cholesterol, and blood glucose levels. In some embodiments, the system comprises a plurality of distributed computers. In some embodiments, wherein the processor is configured to process patient files in the Veterans Affairs Informatics and Computing Infrastructure.

In some embodiments, is a method of predicting patient test results for a cancer patient, comprising: receiving, by a processor, data files, each of the files representing a patient test result; annotating each of the files with a respective indicator of a time associated with the respective test result, to create a respective patient test record; based on the indicators, creating a first time-sequential test record of the patient, comprising each patient test result; comparing the first sequential record to other time-sequential records, of other cancer patients; identifying a cohort of cancer patients having similar sequential records by determining which of the other sequential records have a degree of similarity to the first sequential record; identifying a cohort of cancer patients having similar sequential records by determining which of the other sequential records have a degree of similarity to the first sequential record; and; predicting, by a processor, at least one future patient test result having a significant probability of being out of acceptable range for the cohort.

In some embodiments, the method includes outputting, to an output device, the identified at least patient test result. In some embodiments, the respective test result annotated with the respective indicator of time is identified using a natural language processing technique. In some embodiments, in the step of identifying a cohort of patients having similar sequential records by determining which of the other sequential records have a degree of similarity to the first sequential record, a dynamic programming algorithm is used to obtain the cohort of similar sequential records.

In some embodiments, the algorithm comprises:

$$H ( , j ) = max \{ \begin{matrix}0 \\ H ( i - 1 , j - 1 ) + w ( {a}_{i} , {b}_{j} ) match \text{/} mismatch \\ H ( i - 1 , j ) + w ( {a}_{i} , - ) deletion \\ H ( , j - 1 ) + w ( - , {b}_{j} ) insertion\end{matrix} \} , \\ 1 \leq i \leq m , 1 \leq j \leq n$$

In some embodiments, the at least one patient test result is selected from the group consisting of: urine analysis and biopsy of tissue.

In some embodiments, the other time-sequential records comprises over one million sequential records. In some embodiments, the method further comprises a step of predicting when the at least one future diagnostic test will go out of predetermined range for the patient. In some embodiments, the method further comprises a step of outputting to an output device when the at least one future diagnostic test will go out of predetermined range for the patient.

In some embodiments, the step of identifying a cohort of cancer patients having similar sequential records by determining which of the other sequential records have a degree of similarity to the first sequential record, comprises, prioritizing, by a clinician, the significance of the respective test result. In some embodiments, the step of identifying a cohort of cancer patients having similar sequential records by determining which of the other sequential records have a degree of similarity to the first sequential record, comprises, a step of identifying, by a processor test results that were out of range in the cohort of patients having similar sequential records for patients.

According to certain embodiments, the respective test result in the step of annotating each of the files with a respective indicator of a time associated with the respective test result, to create a respective patient test record; is selected from the group consisting of blood cell count and blood protein testing

In some embodiments, is a non-transitory computer-readable medium encoded with a computer program comprising instructions executable by a processor to perform a method for predicting patient test results for cancer patients, the instructions comprising code for: receiving, by a processor, data files, each of the files representing a patient test results of the patient; annotating each of the files with a respective indicator of a time associated with the respective test result to create a respective patient test record, based on the indicators, creating a first time-sequential record of the patient, comprising each patient test result; comparing the first sequential record to other time-sequential records, of cancer other patients; identifying a cohort of cancer patients having similar sequential records by determining which of the other sequential records have a degree of similarity to the first sequential record; and predicting, by a processor, at least one future patient test result having a significant probability of being out of acceptable range for the cohort.

According to some embodiments, the instructions further comprise code for outputting, to an output device, the at least patient test result. In some embodiments the instructions further comprise code for identifying the respective test result using a natural language processing technique. In some embodiments, the instructions further comprise code for using a dynamic programming algorithm to obtain the cohort of similar sequential records. In some embodiments, the instructions comprise code for using the an algorithm comprising:

$$H ( , j ) = max \{ \begin{matrix}0 \\ H ( i - 1 , j - 1 ) + w ( {a}_{i} , {b}_{j} ) match \text{/} mismatch \\ H ( i - 1 , j ) + w ( {a}_{i} , - ) deletion \\ H ( , j - 1 ) + w ( - , {b}_{j} ) insertion\end{matrix} \} , \\ 1 \leq i \leq m , 1 \leq j \leq n$$

According to some embodiments the at least patient test result is selected from the group consisting of: urine analysis and biopsy of tissue. In some embodiments, the instructions further comprise code for accessing over one million sequential records. In some embodiments, the instructions further comprise code for predicting when the at least one future diagnostic test will go out of predetermined range for the patient. In some embodiments, the instructions further comprise code for outputting to an output device when the at least one future diagnostic test will go out of predetermined range for the patient.

According to certain embodiments, the instructions further comprise code for inputting, by a clinician, prioritizing test results of the significance of the respective test. In some embodiments, the instructions further comprise code for identifying, by a processor of identifying, by a processor test results that were out of range in the cohort of patients having similar sequential records for patients. In some embodiments, the respective test result is selected from the group consisting of blood cell count and blood protein testing. In some embodiments, the instructions further comprise code for processing by distributed computers.

According to some embodiments, the instructions further comprise code for processing patient files in the Veterans Affairs Informatics and Computing Infrastructure. In some embodiments, disclosed is a computing machine comprising the machine-readable medium encoded with a computer program comprising instructions executable by a processor for: receiving, by a processor, data files, each of the files representing a patient test results of the patient; annotating each of the files with a respective indicator of a time associated with the respective test result to create a respective patient test record, based on the indicators, creating a first time-sequential record of the patient, comprising each patient test result; comparing the first sequential record to other time-sequential records, of cancer other patients; identifying a cohort of cancer patients having similar sequential records by determining which of the other sequential records have a degree of similarity to the first sequential record; and predicting, by a processor, at least one future patient test result having a significant probability of being out of acceptable range for the cohort

In some embodiments, is a system for predicting patient test results for a cancer patient, comprising: a patient data file input module configured to receive, by a processor, data files, each of the files representing a patient test result; and a processing module, wherein the processing module is configured to annotate each of the files with a respective indicator of a time associated with the respective diagnostic test, to create a respective patient test record, based on the indicators, create a first time-sequential record of the patient, comprising each test result, compare the first sequential record to other time-sequential records, of other patients, identify a cohort of cancer patients having similar sequential records by determining which of the other sequential records have a degree of similarity to the first sequential record, and predict by a processor, at least one future patient test result having a significant probability of being out of acceptable range for the cohort.

In some embodiments, the system comprises an output module configured to output the identified at least one patient test result that had the highest likelihood of being out of acceptable range for the cohort is selected from the group consisting of: urine analysis and biopsy of tissue. In some embodiments, the processor is configured to identify the test result using a natural language processing technique. In some embodiments, the processor is configured to use a dynamic programming algorithm to obtain the cohort of similar sequential records. In some embodiments, the dynamic programming algorithm is,

$$H ( , j ) = max \{ \begin{matrix}0 \\ H ( i - 1 , j - 1 ) + w ( {a}_{i} , {b}_{j} ) match \text{/} mismatch \\ H ( i - 1 , j ) + w ( {a}_{i} , - ) deletion \\ H ( , j - 1 ) + w ( - , {b}_{j} ) insertion\end{matrix} \} , \\ 1 \leq i \leq m , 1 \leq j \leq n$$

In some embodiments, the at least one patient test result that had the highest likelihood of being out of predetermined range for the cohort is selected from the group consisting of: urine analysis and biopsy of tissue. In some embodiments, the processor is configured to access data files comprising over one million sequential records. In some embodiments, the processor is configured to predict when the at least one future diagnostic test will go out of predetermined range for the patient. In some embodiments, the processor is configured to output to an output device when the at least one future diagnostic test will go out of predetermined range for the patient.

In some embodiments, the processor is configured to receive data from a clinician prioritizing the significance of the respective test result. In some embodiments, the processor is configured to identify test results that were out of predetermined range in the cohort of patients having similar sequential records for patients.

According to certain embodiments, the respective test result used to create the first time-sequential record of the patient, is selected from the group consisting of urine analysis and biopsy of tissue. In some embodiments, the system comprises a plurality of distributed computers. In some embodiments, wherein the processor is configured to process patient files in the Veterans Affairs Informatics and Computing Infrastructure.

Additional features and advantages of the subject technology will be set forth in the description below, and in part will be apparent from the description, or may be learned by practice of the subject technology. The advantages of the subject technology will be realized and attained by the written description and claims hereof as well as the appended drawings.

It is to be understood that both the foregoing general description and the following detailed description are exemplary and explanatory and are intended to provide further explanation of the subject technology as claimed.

### BRIEF DESCRIPTION OF THE DRAWINGS

The accompanying drawings, which are included to provide further understanding of the subject technology and are incorporated in and constitute a part of this specification, illustrate aspects of the subject technology and together with the description serve to explain the principles of the subject technology.

FIG. 1 shows a flowchart of a method of predicting test results for a patient, according to some embodiments of the present disclosure.

FIG. 2 shows a flowchart of a method of predicting test results for a patient, according to some embodiments of the present disclosure.

FIG. 3 illustrates a simplified diagram of a system, in accordance with various embodiments of the subject technology.

FIG. 4 illustrates a simplified block diagram of a server, in accordance with various embodiments of the subject technology.

FIG. 5 is a conceptual block diagram illustrating an example of a system, in accordance with various embodiments of the subject technology.

### DETAILED DESCRIPTION

In the following detailed description, numerous specific details are set forth to provide a full understanding of the subject technology. It will be apparent, however, to one with ordinarily skilled in the art that the subject technology may be practiced without some of these specific details. In other instances, well-known structures and techniques have not been shown in detail so as not to obscure the subject technology.

According to some embodiments, a method of improving patient outcomes is provided by identifying best practice treatment for cohorts of patients and applying them to new patients that are identified as similar.

According to some embodiments, a method of predicting laboratory test results in the near-term for patients is provided by identifying patients that have a statistically significant probability of going out of a predetermined range based on patterns or similar cohorts of patients. As used herein, the term “significant probability” means having a statistically significant probability as viewed by a clinician, for example with a p value of less than 0.05. As used herein, the term “predetermined range” means per clinical guidelines or other guidelines. As used herein, the term “test result” means the outcome of a diagnostic test and the term “future test result” means a test result obtained in the future.

Optimal patient treatment can be achieved by identifying best treatment practices for similar patients. It has been discovered that identifying cohorts of patients who are similar to the patient and applying the best treatment practices found for the cohort may achieve optimal treatment for the patient for whom treatment is sought. Examples of illnesses or conditions for which such a method of applying the best treatment practices found for a similar cohort include cancers, auto-immune diseases, and neurodegenerative diseases. Current cancer treatments include radiation and chemotherapy, which have many serious negative side effects. It is therefore, beneficial to determine a treatment or treatments that may be most effective in a particular patient, prior to commencing any treatment with such negative side effects.

In addition, prediction of future patient laboratory tests can be valuable in treating and preventing disease. It has been discovered that identifying cohorts of patients who are similar to the patient and analyzing the test results of the cohort of patient may achieve accurate prediction of patient test results, and thereby identify patients that have a high probability of going out of range for a particular test. Such test results may include: blood diagnostic tests, (pressure, cholesterol levels, glucose levels, protein levels), urine analysis, blood platelet levels, tissue biopsies, protein levels, heart rate, and other test.

Biological sequence analysis techniques have been used to process DNA, RNA and peptide sequences in order to better elucidate its structure, function, features and transformation. Such biological sequence analysis involves use of biological databases populated by the results of high-throughput production of gene and protein sequences. Comparing new sequences to those with known functions as stored in databases has increased understanding of the biology of an organism from which the new sequence comes. Sequence analysis has also been used to assign function to genes and proteins by the study of the similarities between the compared sequences.

Two main types of sequence alignment currently exist: pair-wise sequence alignment, which only compares two sequences at a time, and multiple sequence alignment, which compares many sequences at one time. Algorithms may be used to align pairs of sequences. Examples of such algorithms include the are the Needleman-Wunsch algorithm and the Smith-Waterman algorithm. Repeat matching alignment may also be used, in which repeating subsequence motifs are identified in the sequence, overlapping alignments where overhanging ends are not penalized. Hybrid alignment techniques may also be used. These hybrid techniques modify the dynamic programming formula to favor specific structures in the sequences. Complex insertion and deletion penalties that are dependent on the initiation and length of the gap or use an affine gap cost structure may also be used. In addition, heuristic alignment algorithms such as Basic Local Alignment Search Tool (BLAST) (Altschul et al. 1990) and alternate versions of BLAST and FASTA (Pearson & Lipman 1988) may also be used. BLAST uses highly matched short seed sequences from which to extend out the alignment. FASTA is a multistep approach that starts with exact matches, extends to ungapped matches and then identifies gapped alignments.

The Needleman-Wunsch algorithm (also referred to as the optimal matching algorithm) performs a global alignment on two sequences and may be used to align protein or nucleotide sequences. The Needleman-Wunsch algorithm is an example of dynamic programming, which simplifies a complicated problem by breaking it down into simpler sub-problems in a recursive manner. In this algorithm, scores for aligned characters are specified by a similarity matrix, which is a matrix of scores which express the similarity between two data points. Higher scores are given to more-similar characters, and lower or negative scores for dissimilar characters.

The Smith-Waterman algorithm is also an example of dynamic programming and has been used for performing local sequence alignment in order to determine similar regions between two nucleotide or protein sequences.

$$H ( , j ) = max \{ \begin{matrix}0 \\ H ( i - 1 , j - 1 ) + w ( {a}_{i} , {b}_{j} ) match \text{/} mismatch \\ H ( i - 1 , j ) + w ( {a}_{i} , - ) deletion \\ H ( , j - 1 ) + w ( - , {b}_{j} ) insertion\end{matrix} \} , \\ 1 \leq i \leq m , 1 \leq j \leq n$$

The Smith-Waterman algorithm compares segments of all possible lengths and optimizes the similarity measure. The Smith-Waterman algorithm finds the optimal local alignment with respect to the scoring system being used. The scoring system may include the substitution matrix scheme and the gap-scoring scheme. A substitution matrix describes the rate at which one character in a sequence changes to other character states over time. Substitution matrices have been used in the context of amino acid or DNA sequence alignments, where the similarity between sequences depends on their divergence time and the substitution rates as represented in the matrix. The primary difference between the Smith-Waterman and the Needleman-Wunsch algorithm is that negative scoring matrix cells are set to zero, which renders the (thus positively scoring) local alignments visible. Backtracking starts at the highest scoring matrix cell and proceeds until a cell with score zero is encountered, yielding the highest scoring local alignment. The application technology used the aforementioned sequence analysis techniques to identify best practice treatment for cohorts of patients and applying them to new patients that are identified as similar by physicians and to identify patients that have high probability of going out of range based on patterns or similar cohorts of patients. Contrary to previous research, (see for example, Lee et al., “Local Alignment Tool for Clinical History: Temporal Semantic Search or Clinical Databases” AMIA 2010 Symposium Proceedings p. 437-441), use of a substitution matrix has been found by Applicant to be successful in identifying best practice treatment for cohorts of patients and applying them to new patients that are identified as similar by physicians and identifying patients that have high probability of going out of range based on patterns or similar cohorts of patients. The substitution matrix is initialized with tunable parameters of MatchWeight (value set for identical match across diagonal (i,i) positions in matrix) and MisMatchWeight (value set for mismatches of variables (i,j) where i is not equal to j). The sequences are aligned with initialized matrix. The predictive utility of the aligned sequences is evaluated with cross validation. Aligned sequences that correctly predict outcome will result in the substitution matrix MatchWeight and MisMatchWeight values incrementing, while alignments that incorrectly predict outcome will result in their weights decrementing. The adjustment of the substitution matrix stops when a cutoff is met for the predictive model.

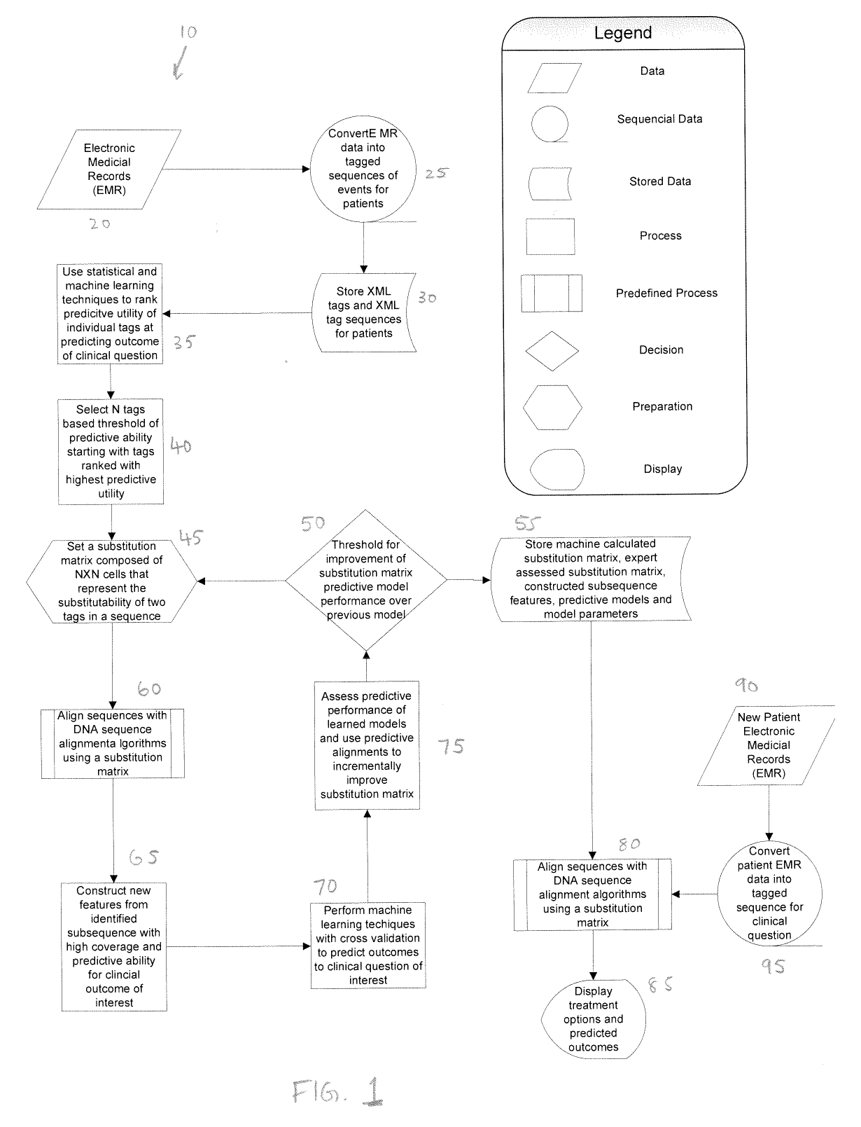

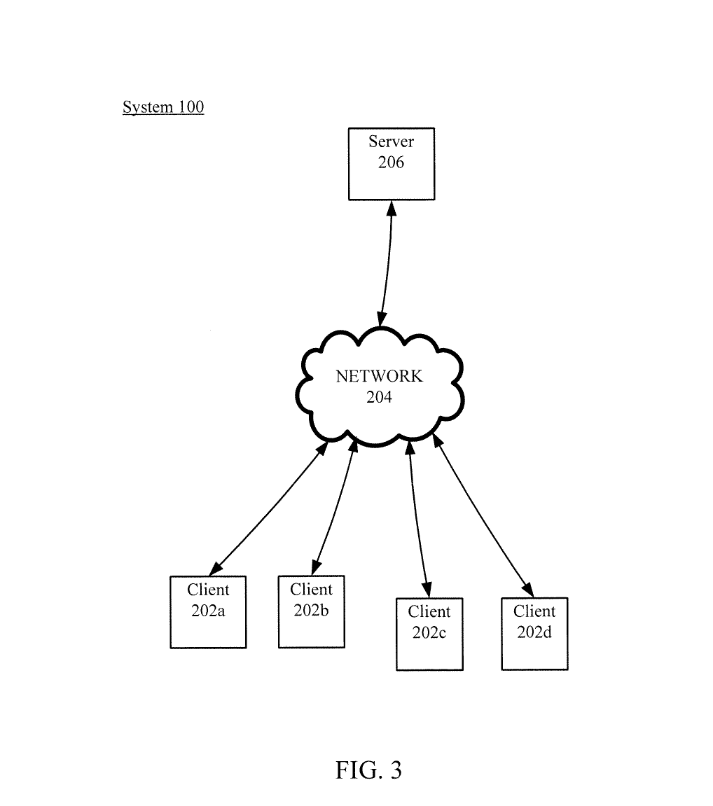

According to some embodiments, as shown in FIG. 1, a similarity matching method 10 may include accessing the electronic medical records (EMR) 20 of patients as stored on a non-transitory computer readable form, such as a computer hard-drive. This EMR may be systematic collection/database or log of electronic medical information about individual patients in digital format that can be shared across different health care settings i.e. accessed by different physicians at different healthcare facilities over a network (as shown in FIG. 3). The Veterans Affairs Informatics and Computing Infrastructure is an example of such a database. The EMR may be accessed via a network connection and may include a range of data, including medical history (e.g. tumor detected, heart attack, stroke, reduction in cognitive ability, onset of autoimmune disorder, anemia etc.), medication, allergies, immunization status, laboratory test results, radiology images, vital signs, personal statistics, like age and weight, and billing information. The EMR maybe updated in real time upon each encounter between the patient and a respective healthcare intervention. As used herein, the term “health care intervention” includes any of, and any combination of lab tests, imaging (x-rays, CT, MRI, ultrasound), surgeries, inpatient and outpatient medical procedures, physical, psychological and other interactions with any health care worker (doctor, nurse, pharmacist, therapist, etc.)

The EMR data may be retrieved and annotated with an indicator of time, thereby converting the EMR data into annotated sequences of health care interventions 25, and creating a sequential record made up of each health care intervention based on the time indicator. As used herein, the term “annotate” includes taking note, annotating, or otherwise supply an indication. As used herein, the term “time” as used herein includes any of, and any combination of: day, date, week, month, year, minute, hour, second, or shorter or longer period of time.

The data may be annotated with the indicator of time by identifying an intervention using a natural language processing technique. Natural language processing techniques may use machine learning to identify an intervention in EMR data and annotate these events with an indicator. For example, the natural language processing technique may identify and annotate clinical terms, biological terms, genomic terms, and laboratory testing terms. The annotated term may have a value (discrete or continuous) and a time.

Exemplary machine learning techniques may include Weka (Waikato Environment for Knowledge Analysis) and ML-Flex. The annotates and annotated sequences of events for the patient may then be converted into a system of annotating, such as a markup language, and stored on a computer readable medium 30. An example of such a markup language is an example of which is Extensible Markup Language (XML). This may be repeated for multiple patients to create a database of annotated patient sequences. The XML annotation or tag thus may have a tagged term, a value (discrete or continuous) and a time.

A processor may be used to process the annotated sequences in the patient database. The processor may use statistical and machine learning techniques to rank the predictive utility of individual annotations at predicting outcome of a clinical question 35. Distributed computers may process the data using various software frameworks, such as Apache Hadoop. Distributed computers may process the data using various software frameworks, such as Apache Hadoop, HBase and Accumulo to store and retrieve the sequential records. Feature selection may be performed on the XML tagged values in the record using subset selection techniques including but not limited to wrappers and filters that search through the space of possible features. Predictive utility rankings may be evaluated using methods including predictive classifiers and feature selection methods such as ReliefF to get a ranking of how well the features separate among the outcomes of the clinical question. ReliefF uses a nearest neighbor approach to numerically rank how well features distinguish between different outcomes.

N annotates are selected based on the threshold of the predictive ability starting with annotates ranked with the highest predictive utility 40. A substitution matrix is then set 45. The substitution matrix may be composed of N×N cells that represent the substitutability of two annotates in a sequence. The sequences may then be aligned 60 using DNA sequence algorithms such as dynamic programming, an example of which is a Smith and Waterman algorithm:

$$H ( , j ) = max \{ \begin{matrix}0 \\ H ( i - 1 , j - 1 ) + w ( {a}_{i} , {b}_{j} ) match \text{/} mismatch \\ H ( i - 1 , j ) + w ( {a}_{i} , - ) deletion \\ H ( , j - 1 ) + w ( - , {b}_{j} ) insertion\end{matrix} \} , \\ 1 \leq i \leq m , 1 \leq j \leq n$$

New features may be constructed from identified subsequences with high coverage and predictive ability for clinical outcome of interest 65. Machine learning techniques may then be performed with cross validation to predict outcomes to clinical questions of interest 70.

The predictive performance of learned models may be assessed and predictive alignments are used to incrementally improve substitution matrix 75. The threshold for improvement of substitution matrix predictive model performance over previous model may be set 50 and used to set the substitution matrix 45. The machine calculated substitution matrix, expert assessed substitution matrix, constructed subsequence features, predictive models and model parameters are stored on a non-transitory computer readable medium 55. In this manner, a cohort of similar sequential records may be obtained by determining which patient records as similar to or relevant to predicting the outcome of a clinical question. The sequences are aligned using DNA sequence alignment algorithms 80 and options and predicted outcomes are displayed 85 via an output device. As used herein, an output device includes any one or and/or a combination of displays, storage, print-out, etc.

Healthcare interventions that were most effective for the similar patient cohort and most predictive of future test results for a new patient may be outputted (e.g. on a display, or printout) by retrieving the new patient's EMR 90, converting the EMR data into a annotated sequence in order to answer clinical questions 95, and then aligning the sequences with DNA sequence alignment algorithms using a substitution matrix 80. In this manner, the most effective health care intervention options and predicted test results for the new patient may be outputted 85. The predicted time when the test results is predicted to go out of a predetermined range is also outputted. For example, the EMR for a new patient may be retrieved as data files of the patient's encounters with various physicians. Terms in the EMR may be identified using a natural language processing technique and annotated 95 with a time indicator to define a patient session. As used herein, the respective patient session is an intervention annotated with an indication of time. Thus, a sequential record may be created which includes each patient intervention based on the time indicators 95. The patient's sequential record may then be compared with other patients' sequential records that are similar to the patient's sequential record by aligning the sequences using DNA sequence algorithms using a substitution matrix 80. In this manner, a cohort of similar sequences may be obtained by determining which of the other patients EMR's are similar to the patient's sequential record and the identifying healthcare interventions (e.g. drug therapy, physical therapy, radiation therapy) that were most effective for patients in the cohort of similar sequential records. Furthermore, a cohort of similar sequences may be obtained by determining which of the other patients EMR's are similar to the patient's sequential record and then predicting outcomes based on patients in the cohort of similar sequential records

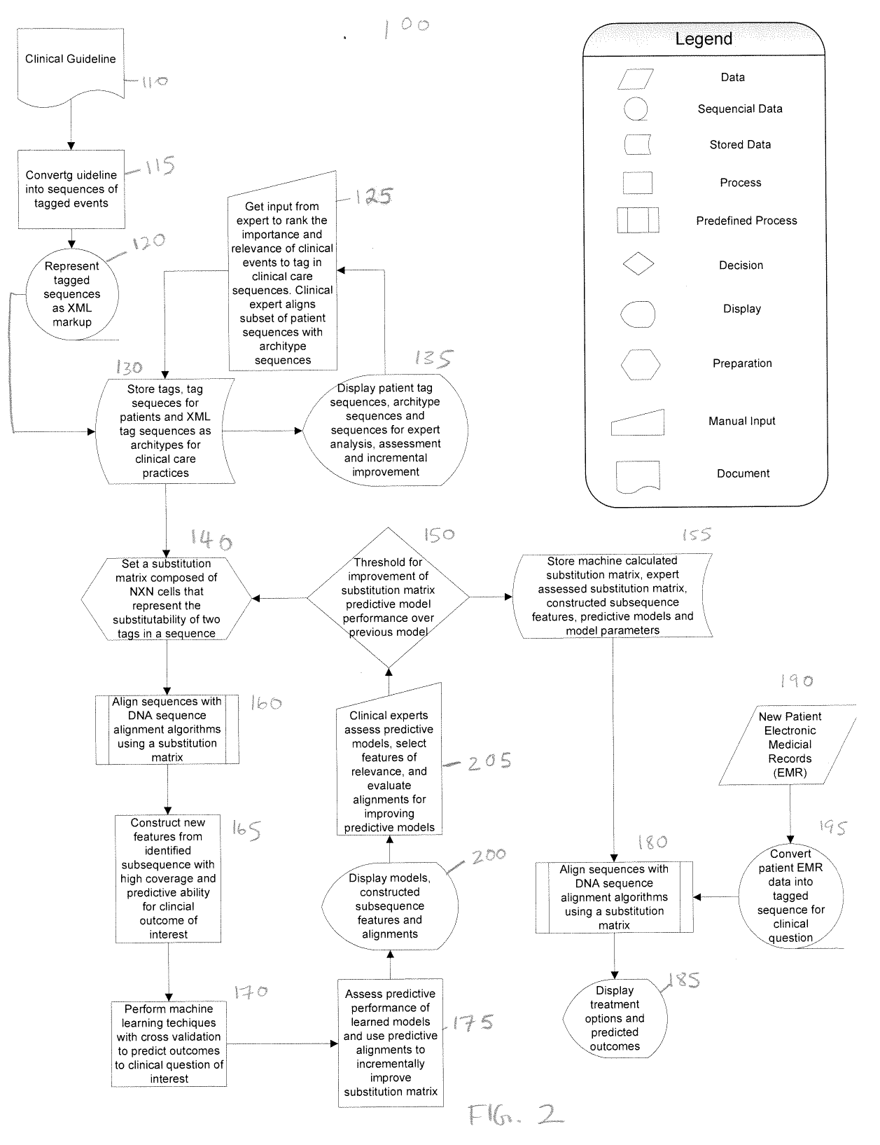

According to some embodiments, as shown in FIG. 2, a similarity matching method with expert input 100, may include accessing a clinical guideline 110 and converting it into sequences of annotated events 115. The annotated sequences may be represented as XML computer readable code 120. An expert, such as a physician, may input data ranking the importance and relevance of clinical events to annotate in clinical care sequences. The clinical expert aligns a subset of patient sequences with archetype sequences 125. The annotates are stored, and sequences for patients and XML annotate sequences are annotated as architypes for clinical care practices 130. Patient annotated sequences, architype sequences and sequences for expert analysis, assessment and incremental improvement are displayed 135.

Following the storage of the annotates 130, a substitution matrix composed of N×N cells that represent the substitutability of two annotates in a sequence is set 140. The sequences are aligned with DNA sequence alignment algorithms 160 as in FIG. 160, using a substitution matrix. New features are constructed from identified subsequence with high coverage and predictive ability for clinical outcome of interest 165. A machine learning technique is performed with cross validation to predict outcomes to a clinical question of interest 170. The predictive performance of learned models may be assessed and predictive alignments maybe used to incrementally improve the substitution matrix 175. The learned models and constructed subsequence features and alignments may be displayed 200. Clinical experts may then assess predictive models, select features of relevance, and evaluate alignments for improving predictive models 205. The threshold for improvement of substitution matrix and predictive model performance over previous model may be set 150. The machine calculated substitution matrix, expert assessed substitution matrix, constructed subsequence features, predictive models and model parameters are stored on a computer readable memory 155. The sequences may then be aligned with DNA sequence alignment algorithms 180 using a substitution matrix. The display treatment options and predicted outcomes may then be displayed 185.

Treatment options and predicted outcomes for a new patient may be displayed by retrieving the new patient's EMR 190, converting the EMR data into annotated sequence in order to answer clinical questions 195, and then aligning the sequences with DNA sequence alignment algorithms using a substitution matrix 180. In this manner, the treatment options and predicted outcome for the new patient may be displayed 185.

### EXAMPLES

### Example 1

A physician wanting to identify the best treatment for lowering the blood pressure of a patient may retrieve the EMR of the patient and submit the EMR for processing by a computer readable program executable by a processor, such as in a computer. The program may convert the EMR data into annotated sequences of events for the patient by annotating each event with a indicator. For example, the annotated sequence may be that the patient first had elevated blood pressure, a day later the patient was prescribed blood pressure medication A, three months later the patient then suffered a heart attack, six months later a different blood pressure medication B was prescribed, two years later the patient then suffered a stroke, and the patient's blood pressure remains elevated. The annotated sequences may then be converted to XML annotates. The patient's sequence may then be compared to a cohort of patients have similar sequences in order to determine which treatment was successful for those other patients. The step of obtaining a cohort of patient having similar sequences, may be achieved by converting EMR data of a large database of patients into annotated sequences of events for each patient by annotating each event with a indicator of time. Statistical and a machine learning technique as implemented by one or many distributed computer processors may be used to rank the predictive utility of individual annotates at predicting the outcome of treating the patient's high blood pressure. For example, the processors may identify a heart attack followed by stroke as the top two predictors in sequence having utility in the clinical question—(how to lower the patient's blood pressure). The executable program may then select the annotates heart disease, stroke, and current use of medication B in a substitution matrix in order to determine those patients with a similar subsequence to the patient's (i.e. identify those patients who suffered a sequence in which a heart attack was followed by a stroke and who are currently taking medication B). Using the executable program, these subsequences of patients determined to be similar are used to construct new features having high coverage and predictive ability for lowering blood pressure. The substitution matrix is saved in a database and the predictive clinical treatment is evaluated for success in the patient. Based on the evaluation, the predictive performance is assessed and incrementally improved.

### Example 2

Example is the same as Example 2, except the relevance of clinical events to annotate in clinical care sequences may be ranked by an expert, such as a physician. The clinical expert may assign a subset of patient sequences with architype sequences.

### Example 3

A physician wanting to predict a patient's laboratory test value may retrieve the EMR of the patient and submit the EMR for processing by a computer readable program executable by a processor, such as in a computer. The program may convert the EMR data into annotated sequences of laboratory test results for the patient by annotating each lab test with a indicator of time. For example, the annotated sequence may be that the patient first had high cholesterol levels, followed by high blood, and the physician would like to predict if and when the patient will have high blood glucose levels indicative of diabetes.

The annotated lab results sequences may then be converted to XML annotates. The patients' sequence may then be compared to a cohort of patients have similar lab test results followed by high glucose levels. The step of obtaining a cohort of patient having similar sequences, may be achieved by converting EMR data of a large database of patients into annotated sequences of events for each patient by annotating each lab test results event with a indicator of time. Statistical and a machine learning technique as implemented by one or many distributed computer processors may be used to rank the predictive utility of individual annotates at predicting if and when the patient may have high blood glucose levels. For example, the processors may identify high blood pressure followed by high cholesterol levels as the top two lab test value predictors in sequence having utility in the clinical question—(if and when the patient may have high glucose levels). The executable program may then select the annotates high blood pressure and high cholesterol levels in a substitution matrix in order to determine those patients with a similar subsequence to the patient's (i.e. identify those patients who suffered a sequence in which high blood pressure was followed by high cholesterol levels). Using the executable program, these subsequences of patients determined to be similar are used to construct new features having high coverage and predictive ability for high glucose levels. The substitution matrix is saved in a database and the predictive test is evaluated for success in the patient. Based on the evaluation, the predictive performance is assessed and incrementally improved.

FIG. 3 illustrates a simplified diagram of a system 100, in accordance with various embodiments of the subject technology. The system 100 may include one ore more remote client devices 102 (e.g., client devices 102a, 102b, 102c, and 102d) in communication with a server computing device 106 (server) via a network 104. In some embodiments, the server 106 is configured to run applications that may be accessed and controlled at the client devices 102. For example, a user at a client device 102 may use a web browser to access and control an application running on the server 106 over the network 104. In some embodiments, the server 106 is configured to allow remote sessions (e.g., remote desktop sessions) wherein users can access applications and files on the server 106 by logging onto the server 106 from a client device 102. Such a connection may be established using any of several well-known techniques such as the Remote Desktop Protocol (RDP) on a Windows-based server.

By way of illustration and not limitation, in one aspect of the disclosure, stated from a perspective of a server side (treating a server as a local device and treating a client device as a remote device), a server application is executed (or runs) at a server 106. While a remote client device 102 may receive and display a view of the server application on a display local to the remote client device 102, the remote client device 102 does not execute (or run) the server application at the remote client device 102. Stated in another way from a perspective of the client side (treating a server as remote device and treating a client device as a local device), a remote application is executed (or runs) at a remote server 106.

By way of illustration and not limitation, a client device 102 can represent a computer, a mobile phone, a laptop computer, a thin client device, a personal digital assistant (PDA), a portable computing device, or a suitable device with a processor. In one example, a client device 102 is a smartphone (e.g., iPhone, Android phone, Blackberry, etc.). In certain configurations, a client device 102 can represent an audio player, a game console, a camera, a camcorder, an audio device, a video device, a multimedia device, or a device capable of supporting a connection to a remote server. In one example, a client device 102 can be mobile. In another example, a client device 102 can be stationary. According to one aspect of the disclosure, a client device 102 may be a device having at least a processor and memory, where the total amount of memory of the client device 102 could be less than the total amount of memory in a server 106. In one example, a client device 102 does not have a hard disk. In one aspect, a client device 102 has a display smaller than a display supported by a server 106. In one aspect, a client device may include one or more client devices.

In some embodiments, a server 106 may represent a computer, a laptop computer, a computing device, a virtual machine (e.g., VMware® Virtual Machine), a desktop session (e.g., Microsoft Terminal Server), a published application (e.g., Microsoft Terminal Server) or a suitable device with a processor. In some embodiments, a server 106 can be stationary. In some embodiments, a server 106 can be mobile. In certain configurations, a server 106 may be any device that can represent a client device. In some embodiments, a server 106 may include one or more servers.

In one example, a first device is remote to a second device when the first device is not directly connected to the second device. In one example, a first remote device may be connected to a second device over a communication network such as a Local Area Network (LAN), a Wide Area Network (WAN), and/or other network.

When a client device 102 and a server 106 are remote with respect to each other, a client device 102 may connect to a server 106 over a network 104, for example, via a modem connection, a LAN connection including the Ethernet or a broadband WAN connection including DSL, Cable, T1, T3, Fiber Optics, Wi-Fi, or a mobile network connection including GSM, GPRS, 3G, WiMax or other network connection. A network 104 can be a LAN network, a WAN network, a wireless network, the Internet, an intranet or other network. A network 104 may include one or more routers for routing data between client devices and/or servers. A remote device (e.g., client device, server) on a network may be addressed by a corresponding network address, such as, but not limited to, an Internet protocol (IP) address, an Internet name, a Windows Internet name service (WINS) name, a domain name or other system name. These illustrate some examples as to how one device may be remote to another device. But the subject technology is not limited to these examples.

According to certain embodiments of the subject technology, the terms “server” and “remote server” are generally used synonymously in relation to a client device, and the word “remote” may indicate that a server is in communication with other device(s), for example, over a network connection(s).

According to certain embodiments of the subject technology, the terms “client device” and “remote client device” are generally used synonymously in relation to a server, and the word “remote” may indicate that a client device is in communication with a server(s), for example, over a network connection(s).

In some embodiments, a “client device” may be sometimes referred to as a client or vice versa. Similarly, a “server” may be sometimes referred to as a server device or vice versa.

In some embodiments, the terms “local” and “remote” are relative terms, and a client device may be referred to as a local client device or a remote client device, depending on whether a client device is described from a client side or from a server side, respectively. Similarly, a server may be referred to as a local server or a remote server, depending on whether a server is described from a server side or from a client side, respectively. Furthermore, an application running on a server may be referred to as a local application, if described from a server side, and may be referred to as a remote application, if described from a client side.

In some embodiments, devices placed on a client side (e.g., devices connected directly to a client device(s) or to one another using wires or wirelessly) may be referred to as local devices with respect to a client device and remote devices with respect to a server. Similarly, devices placed on a server side (e.g., devices connected directly to a server(s) or to one another using wires or wirelessly) may be referred to as local devices with respect to a server and remote devices with respect to a client device.

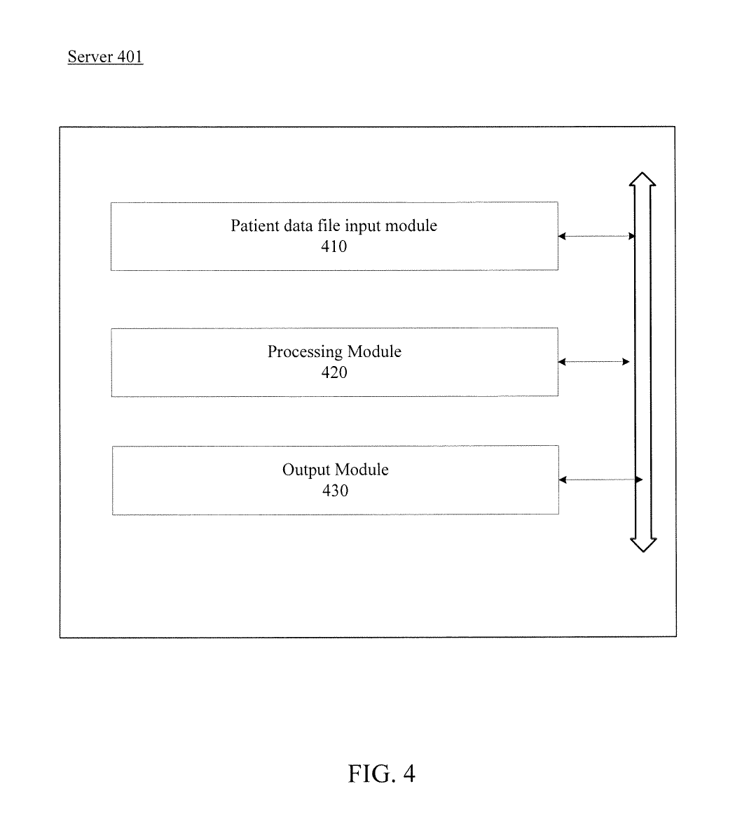

FIG. 4 illustrates a simplified block diagram of a server 106, in accordance with various embodiments of the subject technology. The server 106 comprises a first display module 202, a user input module 204, a second display module 206, a patient input module 208, and an adjustment module 210. In some embodiments, the server 106 is communicatively coupled with the network 104 via a network interface. The modules can be implemented in software, hardware and/or a combination of both. Features and functions of these modules according to various aspects are further described in the present disclosure.

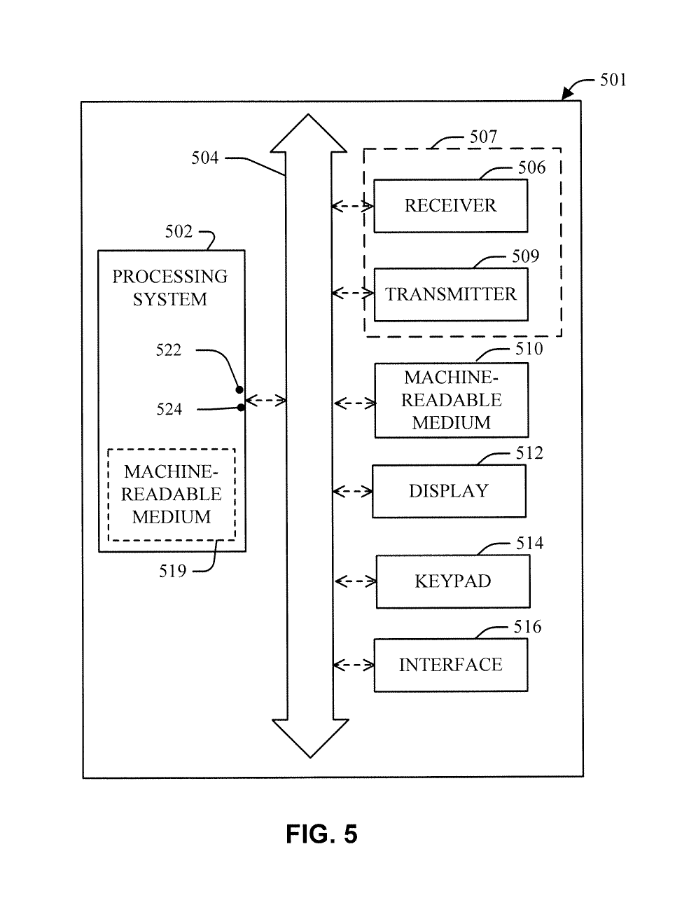

FIG. 5 is a conceptual block diagram illustrating an example of a system, in accordance with various embodiments of the subject technology. A system 601 may be, for example, a client device (e.g., client device 102) or a server (e.g., server 106). The system 601 may include a processing system 602. The processing system 602 is capable of communication with a receiver 606 and a transmitter 609 through a bus 604 or other structures or devices. It should be understood that communication means other than busses can be utilized with the disclosed configurations. The processing system 602 can generate audio, video, multimedia, and/or other types of data to be provided to the transmitter 609 for communication. In addition, audio, video, multimedia, and/or other types of data can be received at the receiver 606, and processed by the processing system 602.

The processing system 602 may include a processor for executing instructions and may further include a machine-readable medium 619, such as a volatile or non-volatile memory, for storing data and/or instructions for software programs. The instructions, which may be stored in a machine-readable medium 610 and/or 619, may be executed by the processing system 602 to control and manage access to the various networks, as well as provide other communication and processing functions. The instructions may also include instructions executed by the processing system 602 for various user interface devices, such as a display 612 and a keypad 614. The processing system 602 may include an input port 622 and an output port 624. Each of the input port 622 and the output port 624 may include one or more ports. The input port 622 and the output port 624 may be the same port (e.g., a bi-directional port) or may be different ports.

The processing system 602 may be implemented using software, hardware, or a combination of both. By way of example, the processing system 602 may be implemented with one or more processors. A processor may be a general-purpose microprocessor, a microcontroller, a Digital Signal Processor (DSP), an Application Specific Integrated Circuit (ASIC), a Field Programmable Gate Array (FPGA), a Programmable Logic Device (PLD), a controller, a state machine, gated logic, discrete hardware components, or any other suitable device that can perform calculations or other manipulations of information.

A machine-readable medium can be one or more machine-readable media. Software shall be construed broadly to mean instructions, data, or any combination thereof, whether referred to as software, firmware, middleware, microcode, hardware description language, or otherwise. Instructions may include code (e.g., in source code format, binary code format, executable code format, or any other suitable format of code).

Machine-readable media (e.g., 619) may include storage integrated into a processing system, such as might be the case with an ASIC. Machine-readable media (e.g., 610) may also include storage external to a processing system, such as a Random Access Memory (RAM), a flash memory, a Read Only Memory (ROM), a Programmable Read-Only Memory (PROM), an Erasable PROM (EPROM), registers, a hard disk, a removable disk, a CD-ROM, a DVD, or any other suitable storage device. Those skilled in the art will recognize how best to implement the described functionality for the processing system 602. According to one aspect of the disclosure, a machine-readable medium is a computer-readable medium encoded or stored with instructions and is a computing element, which defines structural and functional interrelationships between the instructions and the rest of the system, which permit the instructions' functionality to be realized. In one aspect, a machine-readable medium is a non-transitory machine-readable medium, a machine-readable storage medium, or a non-transitory machine-readable storage medium. In one aspect, a computer-readable medium is a non-transitory computer-readable medium, a computer-readable storage medium, or a non-transitory computer-readable storage medium. Instructions may be executable, for example, by a client device or server or by a processing system of a client device or server. Instructions can be, for example, a computer program including code.

An interface 616 may be any type of interface and may reside between any of the components shown in FIG. 6. An interface 616 may also be, for example, an interface to the outside world (e.g., an Internet network interface). A transceiver block 607 may represent one or more transceivers, and each transceiver may include a receiver 606 and a transmitter 609. A functionality implemented in a processing system 602 may be implemented in a portion of a receiver 606, a portion of a transmitter 609, a portion of a machine-readable medium 610, a portion of a display 612, a portion of a keypad 614, or a portion of an interface 616, and vice versa.

As used herein, the word “module” refers to logic embodied in hardware or firmware, or to a collection of software instructions, possibly having entry and exit points, written in a programming language, such as, for example C++. A software module may be compiled and linked into an executable program, installed in a dynamic link library, or may be written in an interpretive language such as BASIC. It will be appreciated that software modules may be callable from other modules or from themselves, and/or may be invoked in response to detected events or interrupts. Software instructions may be embedded in firmware, such as an EPROM or EEPROM. It will be further appreciated that hardware modules may be comprised of connected logic units, such as gates and flip-flops, and/or may be comprised of programmable units, such as programmable gate arrays or processors. The modules described herein are preferably implemented as software modules, but may be represented in hardware or firmware.

It is contemplated that the modules may be integrated into a fewer number of modules. One module may also be separated into multiple modules. The described modules may be implemented as hardware, software, firmware or any combination thereof. Additionally, the described modules may reside at different locations connected through a wired or wireless network, or the Internet.

In general, it will be appreciated that the processors can include, by way of example, computers, program logic, or other substrate configurations representing data and instructions, which operate as described herein. In other embodiments, the processors can include controller circuitry, processor circuitry, processors, general purpose single-chip or multi-chip microprocessors, digital signal processors, embedded microprocessors, microcontrollers and the like.

Furthermore, it will be appreciated that in one embodiment, the program logic may advantageously be implemented as one or more components. The components may advantageously be configured to execute on one or more processors. The components include, but are not limited to, software or hardware components, modules such as software modules, object-oriented software components, class components and task components, processes methods, functions, attributes, procedures, subroutines, segments of program code, drivers, firmware, microcode, circuitry, data, databases, data structures, tables, arrays, and variables.

The foregoing description is provided to enable a person skilled in the art to practice the various configurations described herein. While the subject technology has been particularly described with reference to the various figures and configurations, it should be understood that these are for illustration purposes only and should not be taken as limiting the scope of the subject technology.

There may be many other ways to implement the subject technology. Various functions and elements described herein may be partitioned differently from those shown without departing from the scope of the subject technology. Various modifications to these configurations will be readily apparent to those skilled in the art, and generic principles defined herein may be applied to other configurations. Thus, many changes and modifications may be made to the subject technology, by one having ordinary skill in the art, without departing from the scope of the subject technology.

It is understood that the specific order or hierarchy of steps in the processes disclosed is an illustration of exemplary approaches. Based upon design preferences, it is understood that the specific order or hierarchy of steps in the processes may be rearranged. Some of the steps may be performed simultaneously. The accompanying method claims present elements of the various steps in a sample order, and are not meant to be limited to the specific order or hierarchy presented.

Terms such as “top,” “bottom,” “right,” “left” and the like as used in this disclosure should be understood as referring to an arbitrary frame of reference, rather than to the ordinary gravitational frame of reference. Thus, a top surface, a bottom surface, a front surface, and a rear surface may extend upwardly, downwardly, diagonally, or horizontally in a gravitational frame of reference.

A phrase such as “an aspect” does not imply that such aspect is essential to the subject technology or that such aspect applies to all configurations of the subject technology. A disclosure relating to an aspect may apply to all configurations, or one or more configurations. An aspect may provide one or more examples of the disclosure. A phrase such as “an aspect” may refer to one or more aspects and vice versa. A phrase such as “an embodiment” does not imply that such embodiment is essential to the subject technology or that such embodiment applies to all configurations of the subject technology. A disclosure relating to an embodiment may apply to all embodiments, or one or more embodiments. An embodiment may provide one or more examples of the disclosure. A phrase such “an embodiment” may refer to one or more embodiments and vice versa. A phrase such as “a configuration” does not imply that such configuration is essential to the subject technology or that such configuration applies to all configurations of the subject technology. A disclosure relating to a configuration may apply to all configurations, or one or more configurations. A configuration may provide one or more examples of the disclosure. A phrase such as “a configuration” may refer to one or more configurations and vice versa.

Furthermore, to the extent that the term “include,” “have,” or the like is used in the description or the claims, such term is intended to be inclusive in a manner similar to the term “comprise” as “comprise” is interpreted when employed as a transitional word in a claim.

The word “exemplary” is used herein to mean “serving as an example, instance, or illustration.” Any embodiment described herein as “exemplary” is not necessarily to be construed as preferred or advantageous over other embodiments.

A reference to an element in the singular is not intended to mean “one and only one” unless specifically stated, but rather “one or more.” The term “some” refers to one or more. All structural and functional equivalents to the elements of the various configurations described throughout this disclosure that are known or later come to be known to those of ordinary skill in the art are expressly incorporated herein by reference and intended to be encompassed by the subject technology. Moreover, nothing disclosed herein is intended to be dedicated to the public regardless of whether such disclosure is explicitly recited in the above description.

What is claimed is:

1. A method of predicting an outcome for a patient, comprising:
(a) receiving, by a processor, data files, each of the files representing results of a diagnostic test;
(b) annotating each of the files with a respective indicator of a time associated with the respective test, to create a respective patient test result;
(c) based on the indicators, creating a first time-sequential record of the patient, comprising each patient test result;
(d) comparing the first sequential record to other time-sequential records, of other patients;
(e) identifying a cohort of patients having similar sequential records by determining which of the other sequential records have a degree of similarity to the first sequential record; and
(f) predicting, by a processor and based on the cohort, at least one future test result of the patient, the future test result having a significant probability of being out of a predetermined range.

2. The method of claim 1 further comprising outputting, to an output device, the at least one future test result.

3. The method of claim 1 wherein the respective test annotated with the respective indicator of time is identified using a natural language processing technique.

4. The method of claim 1 wherein in step (e) a dynamic programming algorithm is used to obtain the cohort of similar sequential records.

5. The method of claim 1 further comprising the step of predicting when the at least one future diagnostic test will go out of predetermined range for the patient.

6. The method of claim 1 wherein step (e) further comprises prioritizing, by a clinician, the significance of the respective test.

7. The method of claim 1 wherein step (e) further comprises a step of identifying, by a processor diagnostic tests that were out of predetermined range in the cohort of patients having similar sequential records for patients.

8. The method of claim 1 wherein the patient is a cancer patient.

9. The method of claim 8 wherein the respective test result annotated with the respective indicator of time is identified using a natural language processing technique.

10. The method of claim 8 wherein in step (e) a dynamic programming algorithm is used to obtain the cohort of similar sequential records.

11. The method of claim 8 further comprising the step of predicting when the at least one future diagnostic is predicted to go out of a predetermined range for the patient.

12. A system for predicting patient test results for a patient, comprising:
a patient data file input module configured to receive, by a processor, data files, each of the files representing a patient test result; and a processing module, wherein the processing module is configured to:
annotate each of the files with a respective indicator of a time associated with the respective diagnostic test, to create a respective patient test record;
based on the indicators, create a first time-sequential test record of the patient, comprising each patient diagnostic test;
compare the first sequential test record to other time-sequential records, of other patients;
identify a cohort of patients having similar sequential records by determining which of the other sequential records have a degree of similarity to the first sequential record; and
predict, by a processor, at least one future patient test result having a significant probability of being out of a predetermined range.

13. The system of claim 12, further comprising an output module configured to output the identified at least one future patient test result.

14. The system of claim 12, wherein the processor is configured to use a dynamic programming algorithm to obtain the cohort of similar sequential records.

15. The system of claim 12, wherein the processor is configured to predict when the at least one future diagnostic test will go out of predetermined range for the patient.

16. The system of claim 12, wherein the processor is configured to receive data from a clinician prioritizing the significance of the respective test result.

17. The system of claim 12, wherein the processor is configured to identify patient test results that were out of predetermined range for the cohort.

18. The system of claim 12, wherein the patient is a cancer patient.

19. The system of claim 18, wherein the processor is configured to use a dynamic programming algorithm to obtain the cohort of similar sequential records.

20. The system of claim 18 further comprising the step of predicting when the at least one future diagnostic test will go out of predetermined range for the patient.
